(19) United States
(12) Patent Application Publication
(10) Pub. No.: US 2022/0298876 A1
(43) Pub. Date: Sep. 22, 2022

(54) Wellbore tool assembly

(71) Applicant: Altus Intervention (Technologies) AS, Stavanger (NO)

(72) Inventor: Mauro Antonio Zambrano Puerta, Houston, TX (US)

(21) Appl. No.: 17/690,445

(22) Filed: Mar. 9, 2022

(30) Foreign Application Priority Data
Mar. 16, 2021 (NO) 20210334

(51) Int. Cl. E21B 23/00; E21B 43/119; E21B 37/02

(52) U.S. Cl. CPC E21B 23/001; E21B 43/119; E21B 37/02

(57) ABSTRACT

A tool string arrangement (1) for displacement in a deviating wellbore (9) by a wireline operated tractor (2), said tool string arrangement (1) comprises a clean-out arrangement (4), the clean-out arrangement (4) comprises a rotational motor (40) provided with electrical energy through a wireline (21). The tool string arrangement (1) comprises a perforation arrangement (3) positioned between the wireline operated tractor (2) and the rotational motor (40). A method for using the tool string arrangement (1) is described.

The invention concerns a tool string arrangement adapted for being displaced in a deviating wellbore in the ground by means of a wireline operated tractor. More particularly the tool string arrangement is a combined tool string arrangement with at least two capabilities or mode of actions. Even more particularly, as one of the capabilities, the tool string arrangement is provided with a perforation arrangement for making perforations in a liner at a zone of interest. In addition, the tool string is provided with a rotational motor provided with electrical energy through a wireline as one of the capabilities. The perforation arrangement is positioned between the wireline operated tractor and the rotational motor. One of the capabilities enabled by the rotational motor is to position rotary equipment at the front of the tool string arrangement. The rotary equipment may be a pump, a scraper and a rotational bit. A surface tractor control panel and power panels provide power to the wireline operated tractor and to the tool string through the wireline.

Hydrocarbon wells are drilled to even longer distances and often deviates significantly from a vertical direction. As the wells extend over a long distance they may cross through various zones in the formation in the ground. Some zones are drainage zones and may be desirable to produce oil or gas from, while other zones are less favorable. The pressure in different zones may be different and this creates an unwanted cross flow between the drainage zones. It may also be desirable to control the production rate from various zones. Different techniques are known to drain zones most efficiently and to a low cost.

A common and straight forward low-cost technique is to start drainage from the well toe and to continue to drain from “fresh” zones in steps moving upwards in the wellbore. This technique involves a wellbore of low complexity without expensive components and without restrictions in the wellbore. With this arrangement, heavy and effective intervention equipment may be used for cleaning the liner and for perforating the liner to obtain new drainage zones when needed.

Well intervention techniques used in deviating wells vary but are often based upon using some sort of wireline operated tool string arrangements. In deviating wells, it is efficient to use a wireline-based tractor to displace a tool string within the liner due to the horizontal section of the wellbore. Typically, a perforating operation is as a first step of the operation carried out by a cleaning apparatus to remove debris in the liner. When the liner is open, a next step in the operation is to run the tractor with perforation equipment.

The character of the debris in the liner varies and may be sand, silt, scale and other substances. The amount of the debris i.e. volume of debris, the location of the debris, and the shape of the accumulated debris vary.

Based upon experience, the most cost-effective well intervention technique is chosen, and in many cases the intervention is performed as a wireline-based operation. However, in larger campaigns other heavy intervention systems like coiled tubing may be the most cost-effective technique, especially if the volume of debris in the liner is expected to be substantial. This is often not the case.

A drainage program for the reservoir is established for optimal production from with the aim to obtain a high as possible production rate with low or no debris release from the reservoir into the liner. Formation strength is an important factor to consider when establishing the drainage program and during the production phase. Some zones are weak with sand production as a result. Other zones are stronger and can be drained faster without the drawback of pulling particles into the production stream and liner.

Small amounts of debris in the liner represent little or no issues when perforating the liner to obtain “fresh” drainage zones according to the drainage program. Dunes of particles formed by sand and/or silt may represent an issue and such dunes need to be addressed. Ordinary practice is to first run one or more cleanout runs followed by a run with a perforating gun to open the next drainage zone. A wireline-based operation is a cost effective and safe approach. However, several runs may be needed to collect the debris and remove the debris from the liner before a new drainage zone can be established.

Another problem is that a clean-out run reach in many cases deeper than the following perforation run.

The invention has for its object to remedy or to reduce at least one of the drawbacks of the prior art, or at least provide a useful alternative to prior art.

The object is achieved through features, which are specified in the description below and in the claims that follow.

The invention relates to a downhole tool capable to position a tool into a liner, clean the liner making access to zones acceptable for client and in the same run perforate a new drainage zone.

The invention is defined by the independent patent claims. The dependent claims define advantageous embodiments of the invention.

In a first aspect the invention relates more particularly to a tool string arrangement for displacement in a deviating wellbore by a wireline operated tractor. The tool string arrangement comprises a clean-out arrangement. The clean-out arrangement comprises a rotational motor provided with electrical energy through a wireline. The tool string arrangement comprises a perforation arrangement positioned between the wireline operated tractor and the rotational motor.

The position of the rotational motor enables the tool string to carry rotary equipment at the front or the free end of the tool string arrangement.

A surface tractor control panel and power panels provide power to the wireline operated tractor and to the tool string through the wireline.

The perforating arrangement may comprise at least one perforating gun unit. As an alternative the perforating arrangement may comprise at least one puncher unit. A perforating gun unit has the advantage of quick action and reliable operation mode. Relative long sections of the liner may be perforated in one operation. A puncher unit has the advantage of larger penetration depth and accurate hole formation through the liner and into the formation. The puncher unit may be mechanical, or the puncher unit may be provided with explosives.

The tool string arrangement may comprise a debris collector adjacent to the rotational motor. The rotational motor may be positioned between the perforation arrangement and the debris collector.

The clean-out arrangement may comprise a clean-out tool at a free end of the tool string arrangement. The clean-out tool may be driven by the rotational motor. The clean-out tool may comprise a rotational bit. The clean-out tool may comprise a scraper. In most cases the debris drawn into the liner from the reservoir is a result of weak formation, and the settled-out particles are easy to release and collect. A scraper is designed to sweep the liner efficiently. The scraper may be combined with circulation of fluid to transport the debris into the clean-out tool. The scraper may be combined with suction to transport the debris into the clean-out tool. The scraper may be combined with both circulation of fluid and suction to transport the debris into the clean-out tool. The rotational bit has the capability of releasing solidified debris and grinding the debris to a collectable particle size.

In a second aspect the invention relates more particularly to a method for perforating a liner at a zone of interest within a deviating wellbore. The method comprises to:
provide a tool string arrangement as described above;
displace the tool string arrangement in the deviating wellbore by the wireline operated tractor;
clean the liner for debris until the perforating arrangement is located at the zone of interest;
activate the perforating arrangement; and
displace the tool string arrangement out of the liner and a production tube.

The tool string arrangement may be provided with a debris collector, and the method may comprise to collect at least a portion of the debris which has accumulated within the liner prior to activating the perforating arrangement.

In the following is described examples of preferred embodiments illustrated in the accompanying drawings, wherein:

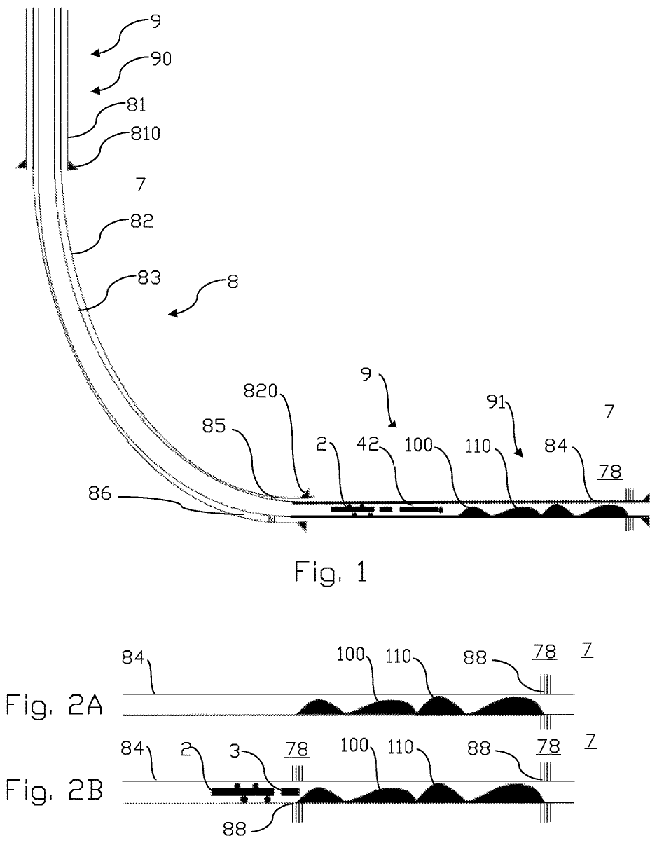

FIG. 1 shows schematically a petroleum well with a deviating section comprising a liner, deposits that have accumulated within the liner, and a perforated section in a drainage zone, as known in prior art;

FIGS. 2A-B show schematically in 2A an enlarged portion of FIG. 1, and in 2B a tractor with a perforation equipment and the position of the perforated section when the debris is not removed prior to the perforation operation, according to prior art;

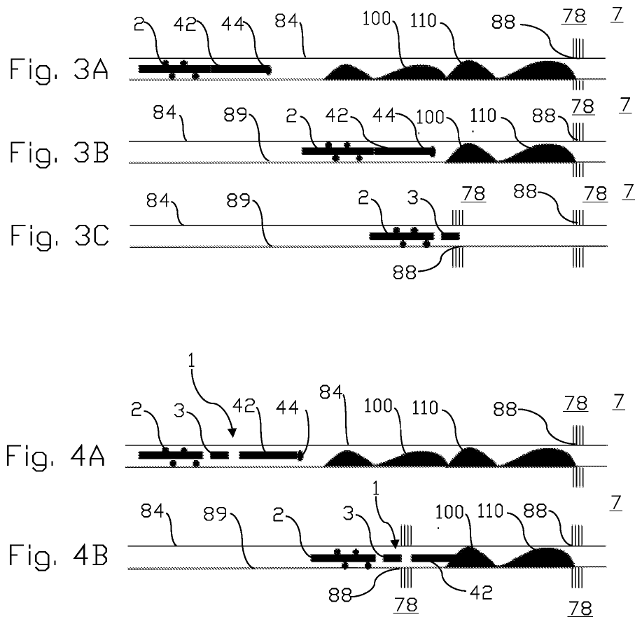

FIGS. 3A-C show schematically in 3A a tractor with a collecting equipment in a first run to remove debris from within the liner, in 3B is shown a second run with the tractor and the collecting equipment to remove more debris from within the liner, and in 3C is shown the tractor with a perforation equipment and the position of the perforated section when the debris is removed prior to the perforation operation, according to prior art;

FIG. 4A-B show schematically in 4A a tractor with a tool string according to the invention prior to removing debris from within the liner, and in 4B is shown the position of the perforated section after at least some of the debris has been removed in the same run;

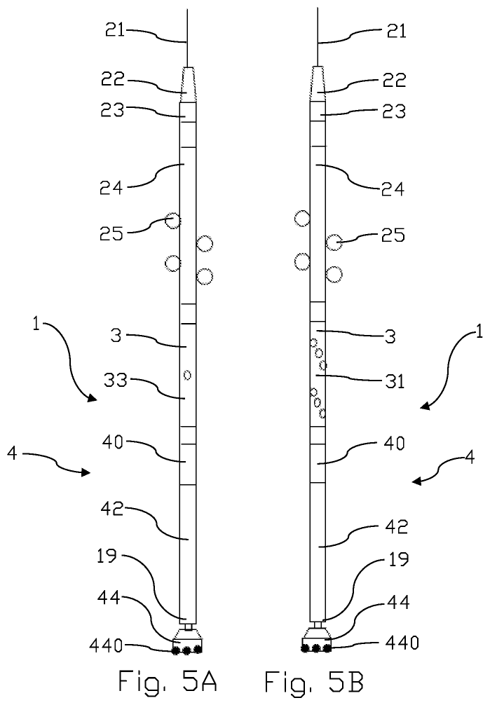

FIG. 5A-B show schematically two embodiments of the invention: a tractor with a perforating arrangement and a collecting device, in 5A is shown a puncher and in 5B is shown a perforating gun; and

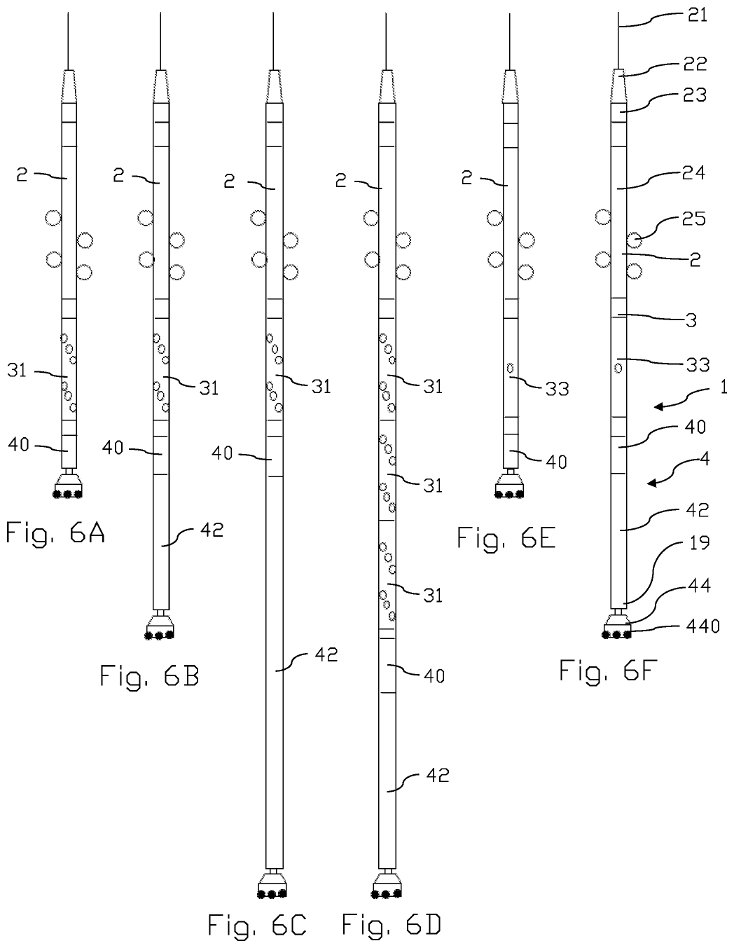

FIG. 6A-F show schematically several embodiments of the invention: a tractor with a rotational motor and a cleaning bit at the front driven by the motor, in 6A is shown a perforating gun between the tractor and the rotational motor, in 6B is in addition shown a collection device between cleaning bit and the rotational motor, in 6C is shown the same as in 6B but with a high capacity collection device, in 6D is shown several units head to tail of the perforating gun to provide a longer drainage zone, in 6E is shown the same as in 6A but with a puncher as the perforating arrangement, and in 6F is shown the same as in 6B but with a puncher as the perforating arrangement.

Petroleum well operations are costly and require minute planning. Previous experience with the well, and knowledge about the formation, formation strengths, and production profile predict to some extent the challenge at hand. Type of tools, available tools and number of runs with equipment into the well must be considered. The examples describe operations where a drainage zone is opened by a perforation arrangement.

In the drawings, the reference numeral 100 indicates a volume of accumulated debris within a liner 84. The accumulated debris 100 may be located in so called dunes 110 as shown in FIGS. 1 to 4. The debris 100 may also create a total blockage of the liner 84. A total blockage provides a known production profile with a steep decline in production volume over a short time period.

A single clean up run with a wire-line operated tractor 2 and a suitable debris collector 42 is sometimes sufficient to gain necessary access to a zone of interest in the well. In some cases, several clean up runs are necessary to gain access as shown in FIGS. 3A-C. After one or several clean up runs, a separate run is performed with a perforation arrangement 3 to create a perforated zone 88 in the liner 84. The perforated zone 88 communicates with a drainage zone 78 in a ground 7. It is also possible to make a run with a perforation arrangement 3 without previous cleaning as shown in FIGS. 2A-B. This is acceptable if the new perforated zone 88 is not located too far from the previous perforated zone 88.

In some cases, it occurs that the run with the perforation arrangement 3 does not reach the depth obtained by the final clean-up run, even if the run is carried out straight after the clean-up run.

Reference numeral 9 indicates a well bore in the ground 7. The well bore 9 comprises of a vertical section 90 and a deviating section 91. A completed well 8 comprises several casings 81 of diminishing diameters 81, 82. Two casings 81, 82 are shown in FIG. 1. The casings 81, 82 are provided with casing shoes 810, 820. The completed well 8 comprises a central production tube 83, and the production tube 83 is connected to the liner 84. The liner 84 is provided with a terminal liner shoe 840. The liner 84 is located with the deviating section 91. A production packer 85 seals an annulus 86 between the production tube 83 and the casing 82. The liner 84 comprises the perforated zone 88 which is adapted to drain fluid from the drainage zone 78 in the ground 7.

Reference numeral 1 indicates a tool string arrangement according to the invention. The tool string arrangement 1 is adapted for connection to a wireline operated tractor 2, and a surface tractor control panel (not shown) and power panels (not shown) provides power to the tractor 2 and to the tool string 1. The tractor 2 is adapted to displace the tool string arrangement 1 within the production tube 83 and the liner 84.

The tool string arrangement 1 comprises in sequence from the tractor 2 towards a free end portion 19 of the tool string 1: a perforating arrangement 3 and a clean out arrangement 4. The clean out arrangement 4 comprises at least a rotational motor 40 and a clean out tool 44 driven by the rotational motor 40. The clean out arrangement 4 may comprise a debris collector 42 adjacent to the clean out tool 44. The clean out tool 44 may be a rotational bit 440. The rotational bit 440 may be a rock bit, a PDC bit (polycrystalline diamond compact bit), or a grinding bit. The clean out tool 44 may be a rotating scraper (not shown). A shaft (not shown) driven by the rotational motor 40 extends through the debris collector 42 and connects the rotational motor 40 to the clean out tool 44. At least a portion of the shaft within the debris collector 42 may form an auger screw for mechanical transport of debris into the debris collector 42. In an alternative embodiment the clean out tool 44 may be a suction-based tool. The rotational motor 40 powers a pump (not shown) that creates a flow path through the debris collector 42. In an alternative embodiment the clean out tool 44 may be a tool that combines a mechanical filling and a suction filling of the debris collector 42.

The tractor 2 is supplied with electrical power from a surface (not shown) through a wireline 21. The tractor 2 comprises a cable head 22 and a swivel 23 between the cable head 22 and a tractor body 24. The wireline 21 is connected to the cable head 22. The tractor 2 comprises wheels 25 for propulsion (see FIGS. 5A-B).

The perforation arrangement 3 may in one embodiment comprise at least one perforating gun unit 31. The perforating gun unit 31 may comprise of a tubing conveyed perforation (TCP) type of perforating gun. The tool string 1 may comprise several perforating gun units 31 head to tail. TCP perforating guns are as such known in the art. As the name indicates, TCP perforating guns are adapted to be displaced within a bore hole by a drill-pipe or by a coiled tubing. The TCP perforating guns are located at the free end of the drill pipe or the coiled tubing.

The perforation arrangement 3 may in one embodiment comprise at least one puncher unit 33. The puncher unit 33 may be an explosive driven puncher unit 33, or the puncher unit 33 may be a mechanical puncher unit 33. The tool string 1 may comprise several puncher units 33 head to tail.

The tractor 2 provides conveyance for the tool string arrangement 1. The tractor 2 also provides weight on bit in embodiments where the clean out tool 44 is a rotational bit 440. The tractor's 2 wheels 25 anchor the tractor 2 and the tool string arrangement 1 to the liner's 84 internal wall 89 and resist the torque provided by the rotational motor 40.

During the clean-up operation, the perforation arrangement 3 acts as an extension between the tractor 2 and the clean-out arrangement 4. The clean-out arrangement 4 is provided with power from the tractor 2 by an electrical cable through the perforation arrangement 3.

Safe mode and safe handling are in general important when handling tool-strings with explosives. The combination of an electrical motor in the tractor 2 and a perforation arrangement 3 is handled with special modules that separate current between the motor and the firing system in the perforation arrangement 3. Combining the perforation arrangement 3 between the tractor 2 and the electrical rotational motor 40 complicates the all-important safety regime.

Control of the electrical current may be done using at least three different techniques:

Firstly, if the well may be pressurized after the clean-up sequence, a pressure switch could be used to ignite explosives within the perforation arrangement 3. The electrical connection going through the perforation arrangement and connecting the rotational motor 40 with the power panel (not shown) at the surface, is led past and not connected to the booster charge in the perforation arrangement 3. Pressurizing the well to above a set threshold ignites the booster charge and subsequently the perforating charges safely.

Secondly, if pressurizing the well isn't an option, e.g. due to open communication to the reservoir, a battery pack and a controlled timer system may be used. Electrical feed-through will go through the perforation arrangement 3 and are always isolated from the ignition system in the perforation arrangement 3. The timer and battery pack are known per se and may in addition be provided with sensors to reset the timer for better control. Sensors may be a temperature sensor, a pressure sensor, an inclination sensor, an accelerometer, a noise sensor, and sensors for detecting electrical activity. When a pre-set time has passed without the timer being re-set, the battery timer arrangement sets off the booster charge, leading to a controlled perforation of the liner 84.

Thirdly, an option for setting off the booster charge is to connect the booster charge directly to the surface control panel via the downhole electronics in the wireline tractor control system (not shown). In this arrangement voltage protection modules (not shown) are a must for safe control of the distribution of electric current downhole. The main safety arrangement provided by a voltage protection module may be just one safety fixture. Additional safety arrangements like sensors and set thresholds may also be used.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements.

The mere fact that certain measures are recited in mutually different dependent claims does not indicate that a combination of these measures cannot be used to advantage.

1. A tool string arrangement for displacement in a deviating wellbore by a wireline operated tractor, said tool string arrangement comprises:
a clean-out arrangement, the clean-out arrangement comprises a rotational motor provided with electrical energy through a wireline (21),
the tool string arrangement further comprises a perforation arrangement positioned between the wireline operated tractor and the rotational motor.

2. The tool string arrangement according to claim 1, wherein the perforating arrangement comprises at least one perforating gun unit.

3. The tool string arrangement according to claim 1, wherein the perforating arrangement comprises at least one puncher unit.

4. The tool string arrangement according to preceding claims claim 1, wherein the clean-out arrangement comprises a debris collector adjacent to the rotational motor.

5. The tool string arrangement according to claim 1, wherein the clean-out arrangement comprises a clean-out tool at a free end of the tool string arrangement, the clean-out tool being driven by the rotational motor.

6. The tool string arrangement according to claim 5, wherein the clean-out tool comprises a rotational bit.

7. A method for perforating a liner at a zone of interest within a deviating wellbore, the method comprises:
providing a tool string arrangement for displacement in a deviating wellbore by a wireline operated tractor, the tool string arrangement comprising a clean-out arrangement which comprises a rotational motor provided with electrical energy through a wireline, the tool string arrangement further comprising a perforation arrangement positioned between the wireline operated tractor and the rotational motor;
displacing the tool string arrangement in the deviating wellbore by the wireline operated tractor;
cleaning a liner for debris until the perforating arrangement is located at the zone of interest;
activating the perforating arrangement; and
displace displacing the tool string arrangement out of the liner and a production tube.

8. The method according to claim 7, wherein the tool string arrangement is provided with a debris collector, and the method comprises collecting at least a portion of the debris accumulated within the liner prior to activating the perforating arrangement.
